(19) United States
(12) Patent Application Publication
(10) Pub. No.: US 2010/0162261 A1
(43) Pub. Date: Jun. 24, 2010

(54) Method and System for Load Balancing in a Distributed Computer System

(75) Inventor: Laksmikantha Hosahally Shashidhara, Bangalore, Karnataka (IN)

Correspondence Address: INTELLECTUAL PROPERTY LAW GROUP LLP, 12 SOUTH FIRST STREET, SUITE 1205, SAN JOSE, CA, 95113, US

(73) Assignee: PES INSTITUTE OF TECHNOLOGY, Bangalore, Karnataka (IN)

(21) Appl. No.: 12/600,656

(22) PCT Filed: May 5, 2008
(86) PCT No.: PCT/IN08/00283

§ 371 Date: Nov. 17, 2009

(30) Foreign Application Priority Data
May 17, 2007 (IN) 1041/CHE/2007

(51) Int. Cl. G06F 15/173; G06F 9/46; G06F 1/12

(52) U.S. Cl. 718/105; 709/224; 713/400

(57) ABSTRACT

In an embodiment, a distributed computer system comprises a plurality of computers connected in substantial logical ring architecture. The computers are configured having a synchronized clock operation. At least one predetermined token designated with any one of a busy or an idle status circulates through the logical ring, wherein the computers are configured to check the status and give away or receive a predetermined job for completion, based on one or more predetermined conditions. Further, any deadlock generated is released by preempting the jobs based on predetermined criteria.

### FIELD OF THE INVENTION

This invention relates generally to distributed computer systems, and more particularly to, methods and systems for work load balancing in distributed computer systems.

### BACKGROUND OF THE INVENTION

Ever since the computer was invented, people have been trying to exploit it, trying to find out how best it can be made use of. Starting from diskless workstations to disked, timesharing and parallel computers, now it is the turn of distributed computer systems configured for not letting any computer in a network to be idle even for a fraction of a second.

Distributed computer system is a system of interconnected, individual, autonomous and disked computers that do not share their memory but communicate only through message passing. The distributed computer system is a contrast technology to a centralized computer system. In a centralized computer system, one computer executes one job. In the distributed computer system, an attempt is made to divide a job from an owner node of the network into several sub jobs wherein each sub-job gets executed at a separate node and then combined result is sent back to the owner node.

The distributed computer system is of great use in reducing the load of overloaded computers and in turn make an efficient use of CPU cycles of all the computers especially, the idle computers in the network. The entire system works like a single unit and gives a feeling of ownership to a user irrespective of the computer in which the job is processed, either in part or full and the resources made use of. This evades the necessity of the resources that a computer should posses in order to make best use of it. The term “resources” is referred hereto, to an operating system, a memory, a printer, etc.

Different views exist on the distributed computer systems, depending on the requirement and/or applications. In the distributed computer system, a processor is configured to balance its load to minimize overloading by sharing the load with idle computers. Consequently, for an employee, the distributed computer system is a means of sharing the physical resources like printer, logical resources e.g. files, etc. For an entrepreneur company, the distributed computer system should be scalable i.e., it should allow an incremental growth from a small investment (number of computers) to a step-by-step extension. For a military application, it should be reliable, i.e., even if one or a few systems fails, it should not bring down the whole system.

As viewed by the processors in the distributed computer system, an individual computer is kept idle only when all other computers are idle or are moderately loaded i.e., no processes are kept waiting in any other computer of the entire system. Whenever a computer is idle and there is an overloaded computer in the network, then the idle computer if it can, is configured to takeover the load of the overloaded computer as shown in FIG. 1. The means adopted to enable each one of the computers to know about the status of other computers of being idle or being busy has been an important area of research. Conventionally, this is done by two methods, namely, (i) distributed method and (ii) centralized method, which are explained in the following description.

In the distributed method, the idle computer itself announces its idleness by broadcasting a message indicative of the idle status and along with configuration information e.g. its processor, co-processor, memory, speed, files available etc. The message is sent to all other computers and also to itself, as shown in FIG. 4. Upon receiving the message, all the computers are configured to make an entry in their dedicated “idle directory or registry”, about the idle computer and its features. Whenever a computer in the network becomes overloaded, i.e., the number of pending processes in the waiting queue goes beyond a predefined threshold, then the computer starts searching for an idle computer to transfer some of its jobs.

Therefore, whenever there is a likelihood of overloading, such computer searches its idle directory to find a suitable idle computer for processing the job. If it finds any, it sends the job to the idle computer. The idle computer, upon receiving the job, first broadcasts another message to all other computers and to itself saying “I'm going busy again” and then starts processing the job. All the computers upon receiving this message, delete the entry formerly made. As another case, the idle computer itself might get a new job. Accordingly, the idle computer broadcasts a message intimating all the other computers about it “going busy once again” and then starts processing the new job.

In the centralized method, a single computer called the “coordinator” takes over the job of finding, identifying and allocating the jobs for the idle computer. The coordinator maintains two directories, one with the information of all the idle computers in the network and a flag to say whether the computer is idle or busy, and another directory to list out the requests from all the overloaded computers to reduce their load along with a list of requirements e.g. processor, memory, coprocessors etc., to accomplish a task. Individual computers do not maintain any such directory. In this case, the coordinator can be of two types:
a passive coordinator
an active coordinator

In case where the coordinator is passive, the coordinator itself does not initiate any process bust responds to the individual computer's requests. Whenever any computer goes overloaded, such computer sends a message to the coordinator with the details of the job and its requirements as shown in FIG. 2. The coordinator makes an entry of the details in a separate directory. Similarly whenever a computer becomes idle, such computer intimates to the coordinator for allotment of any suitable job available.

Upon receiving a job request, the coordinator searches the directory of several waiting jobs available, and selects the best one among those and allocates the chosen job to an idle computer by sending a message and intimating the overloaded computer to transfer the job to the idle computer. If no suitable jobs are available for the requested idle computer, an entry is made in another directory about the availability and idleness of the computer. After allocating and receiving an acknowledgement from both overloaded and idle computers, the coordinator deletes the respective entries form both the directories.

In the case of an active coordinator, the coordinator takes the initiation and keeps surfing periodically, all the computers about the status as shown in FIG. 3. After each surf, if there is a need for an overloaded computer to transfer its load to any other idle computer, then a search is made in a dedicated directory of idle computers. If a suitable computer is found, then the job from the overloaded computer is allocated to an idle computer and the entry is deleted from the directory. If a suitable idle computer is not found, then an entry of the job is made in the respective directory and the process continues.

Similarly, if a computer is idle and the coordinator notices it, the coordinator first searches for a suitable job in the corresponding directory to allot for the idle computer. If not found, a corresponding entry is made in the dedicated idle directory. The advantage of this method is that the computers need not worry about the announcement and/or allotment. But the disadvantage is that if the coordinator goes down then the whole system goes down.

In the above-mentioned methods, allotment of the best job to the idle computer from the overloaded computer is done by some well known methods like first come first served, where the preference is given to the job that arrived first, or the shortest job will be given the first preference. In these methods, the chance of starvation exists and not all the criteria are considered to make it efficient and suitable for all best and worst conditions.

Moreover, to have proper communication and load sharing/balancing between the computers, the clocks of the computers need to be set to a standard or to a common clock value. Conventionally, this is fulfilled by the methods like Berkeley, Cristian, distributed averaging methods. One of centralized and simplest of all, known as Cristian algorithm, where a passive dedicated computer e.g. a time server, synchronizes all the computers in turn their clocks. Periodically each computer sends a request to the time server asking for current time. The time server responds with a message containing its current time C_{UTC} (UTC: Universal Coordinated Time). The major problem with Cristian method is a centralized dependency, the (over) load on timeserver, and hard-to-achieve scalability.

Another known centralized method, called as Berkely algorithm has an active timeserver that keeps polling every computer periodically to ask “what time is it?”. Based on the answers, the time server computes the average time and informs all other computers to advance or slow down their clocks to new found average time and the operator sets the time server's time manually, periodically. In this method, centralized dependency on the time server repeats. However, UTC is not guaranteed. The method involves human intervention that is susceptible to errors. This method also involves computation, which is time and resource consuming. Although the centralized dependency gets evaded through distributed methods like Averaging algorithm, it has many drawbacks such as, each clock setting or a synchronization attempt needs N×N messages (N is the number of computers in the network) to be transferred (broadcasted), which induces heavy traffic and leads to problems like congestion.

Further, “dead lock” is a serious issue in distributed computer systems. Dead lock is a condition wherein some or all the computers in the network are in an indefinite waiting state, waiting for some resources which are acquired by other computers of the network. As the distributed system tries to share and make use of the resources to the utmost extent, it is more vulnerable to deadlock. The problem of deadlock is more serious in distributed than in centralized system as it might bring many computers to halt, that in worst case all the computers in the network may be at halt due to dead lock. One of the common measures followed to come out of dead lock is preemption of job. The challenge is to identify the job to be preempted. The well known criteria to preempt the job used conventionally, include the number of resources the job is making use, or the processor time the job has already used, the number of child processes it has, or the number of dependent processes etc., this might lead to starvation, inefficient use of processor time, etc.

Therefore, from the above known methods, it is apparent that there exists a need to (i) eliminate the need for any centralized dependency and heavy network traffic (ii) minimize starvation and make use of maximum criteria for making the entire system efficient and suitable for all best and worst conditions (iii) provide a dead lock free operation (iv) utilize minimum resources, consume less time and reduce human intervention for an error free operation.

### SUMMARY OF THE INVENTION

In an embodiment, a load balancing method in a distributed computer system using an idle token, comprises the actions of (i) connecting a plurality of computers in a substantial logical ring architecture based on one or more predetermined criteria; (ii) counting the number of idle and overloaded computers, periodically; (iii) circulating at least one predetermined idle token through the logical ring if the number of idle computers exceeds the number of overloaded computers; (iv) configuring at least one idle computer to acquire the idle token for framing and thereby circulating a message indicative of idle state and configuration data of the idle computer to other computers in the logical ring; and (v) configuring at least one overloaded computer to transfer a predetermined job to the idle computer for completion, based on the idle state and the suitability of the configuration to complete the job from the overloaded computer.

In another embodiment, a load balancing method in a distributed computer system using a busy token, comprises the actions of (i) connecting a plurality of computers in a substantial logical ring architecture based on one or more predetermined criteria; (ii) counting the number of idle and overloaded computers periodically; (iii) circulating at least one predetermined busy token through the logical ring if the number of overloaded computers exceeds the number of idle computers; (iv) configuring at least one overloaded computer to acquire the busy token, frame and thereby circulate a message indicative of busy status and required resources for completing a predetermined job from the overloaded computer to other computers in the logical ring; and (v) configuring at least one idle computer to check the message and provide a job request to the overloaded computer depending upon the availability of required resources for completion of the job, wherein the overloaded computer transfers a job to the idle computer subsequent to the request.

In yet another embodiment, a distributed computer system comprises, (i) a plurality of computers connected in a substantial logical ring architecture; (ii) said computers configured having a synchronized clock operation; and (iii) at least one predetermined token designated with any one of a busy or an idle status circulating through the logical ring, wherein the computers are configured to check the status and give away or receive a predetermined job for completion, based on one or more predetermined conditions.

### BRIEF DESCRIPTION OF THE DRAWINGS

FIG. 1 shows a schematic view of load sharing in a typical distributed system.

FIG. 2 shows the centralized method of identification of idle computers in a typical distributed computer system wherein the coordinator is passive.

FIG. 3 shows the centralized method of identification of idle computers in a typical distributed computer system wherein the coordinator is active.

FIG. 4 shows a schematic view of idleness status announcement in a typical distributed system.

FIG. 5 shows a block diagram of a distributed computer system according to an embodiment of this invention.

FIG. 6 shows the synchronization of all the computers in the distributed computer systems using a time synchronizing token according to an embodiment of this invention.

FIG. 7 shows the identification of idle computer using an idle token according to an embodiment of this invention.

FIG. 8 shows the identification of idle computer using a busy token according to an embodiment of this invention.

FIG. 9a through 9f show the flow chart for the identification of idle computers along with synchronizing and scheduling the jobs according to an embodiment of this invention.

FIGS. 9g and 9h show the flow chart of deadlock release method according to an embodiment of this invention

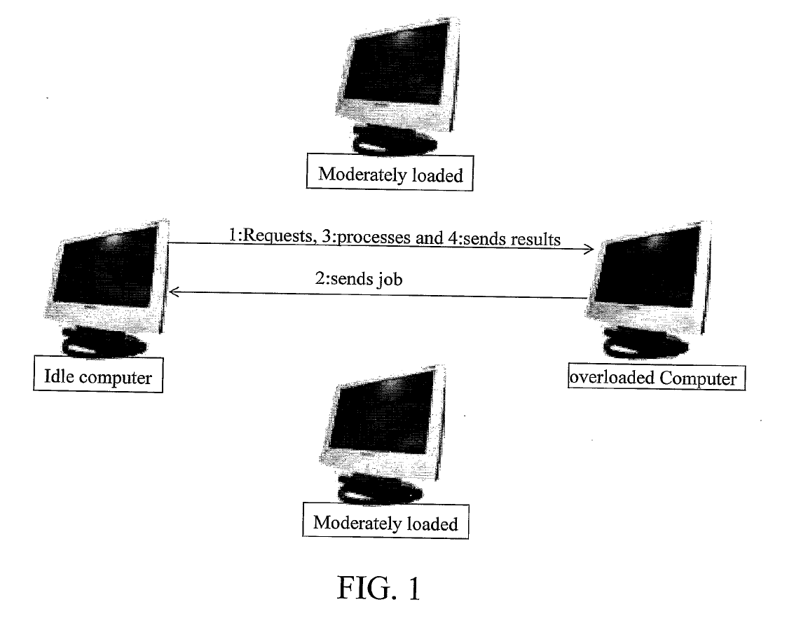

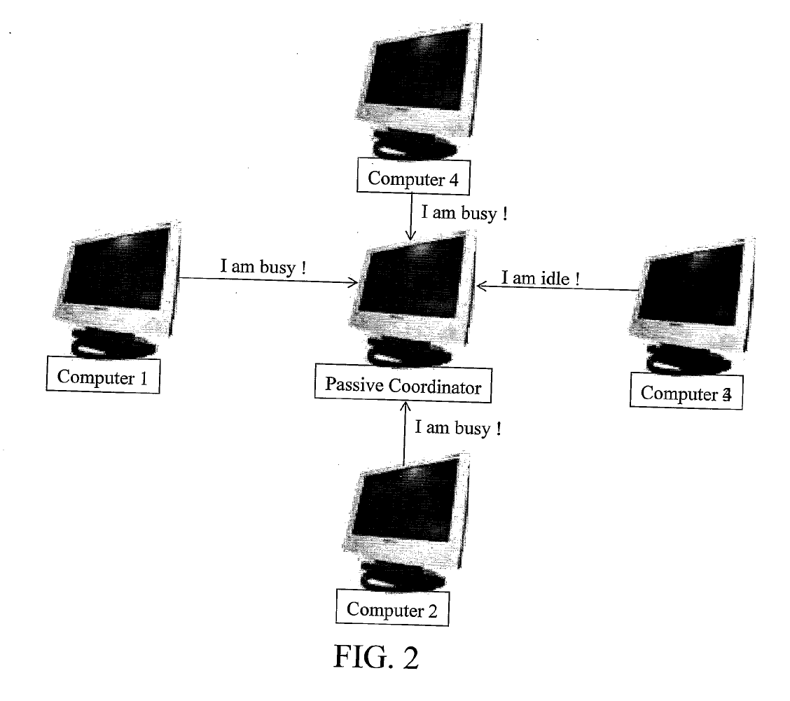

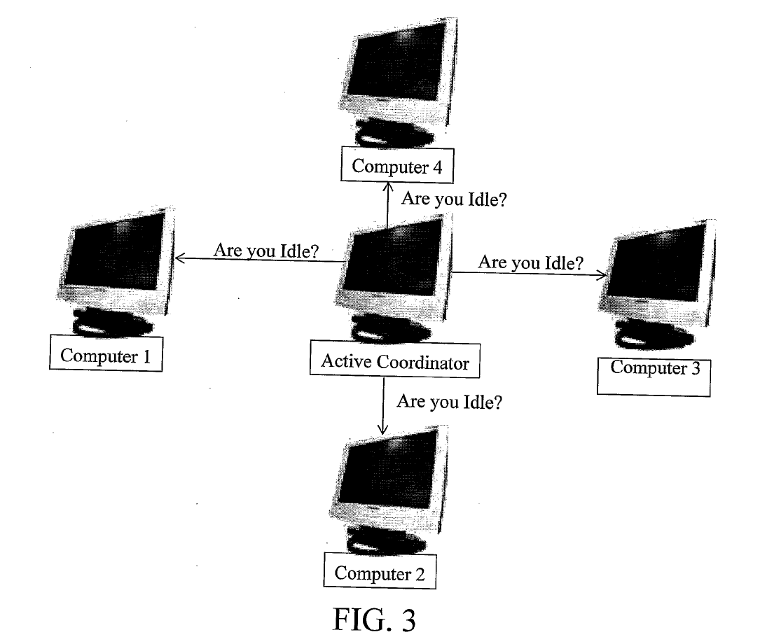

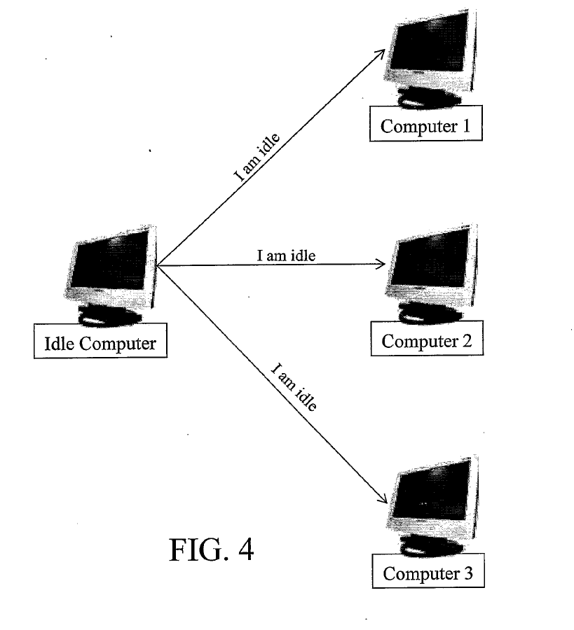

### DETAILED DESCRIPTION OF THE INVENTION

Various embodiments of this invention provide a method and system for load balancing in a distributed computer system, especially for use in an entrepreneur company. However, the embodiments are not limited and may be used in connection with various applications such as, military applications, etc.

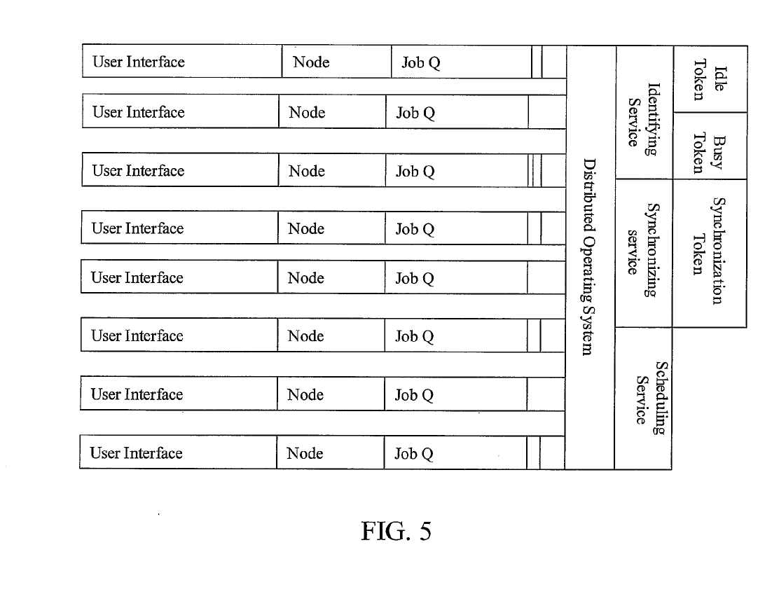

FIG. 5 shows an embodiment of a distributed computer system according to this invention, wherein the system comprises a plurality of computers connected in logical ring architecture based on predetermined criteria. Examples of such criteria include physical distance, processor-id, priority of the processor, etc. A special bit pattern hereinafter referred to as “token” circulates through the logical ring as soon as the distributed computer system restarts. The token may include but not limited to, an idle token indicative of idle state of a computer, a busy token indicative of an overload state of a computer and a time synchronizing token indicative of a time synchronous to all the computers in the logical ring. The release and circulation of the token is taken care by a distributed operating system. The operating system may be configured to check the closed state of the topology prior to release of the token. The operating system is also configured to count the number of idle and overloaded computers periodically and release the appropriate token depending on counting result.

For example, if the number of idle computers is more than the number of overloaded computers, then the operating system releases one or more idle tokens for circulation within the logical ring. If the number of overloaded computers is more than the number of idle computers, then the operating system releases one or more busy tokens for circulation within the logical ring. Further operation and methods of load balancing in the distributed computer system is described in the following description.

Depending on the number of idle and overloaded computers at a particular time instant, the method of load balancing according to some embodiments of this invention, is practiced by (i) idle token method, and (ii) busy token method.

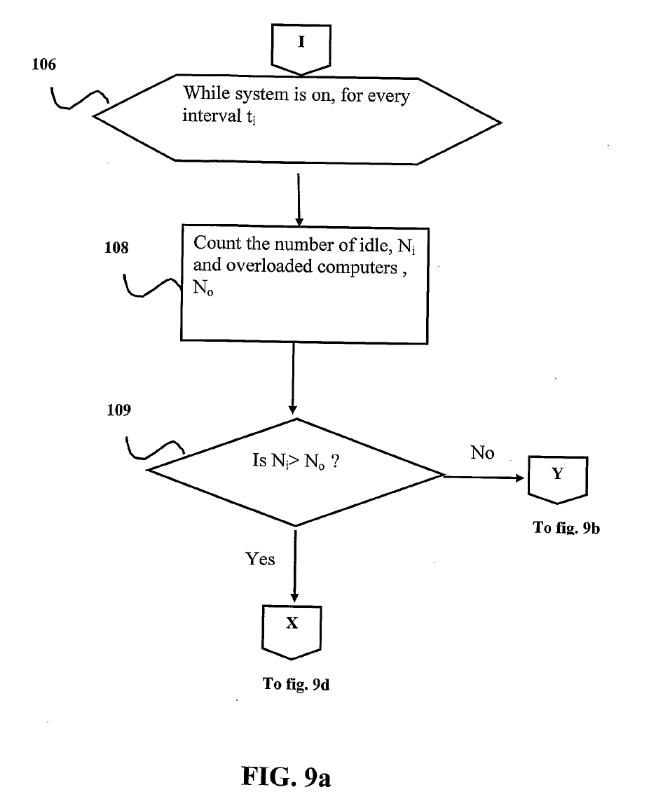

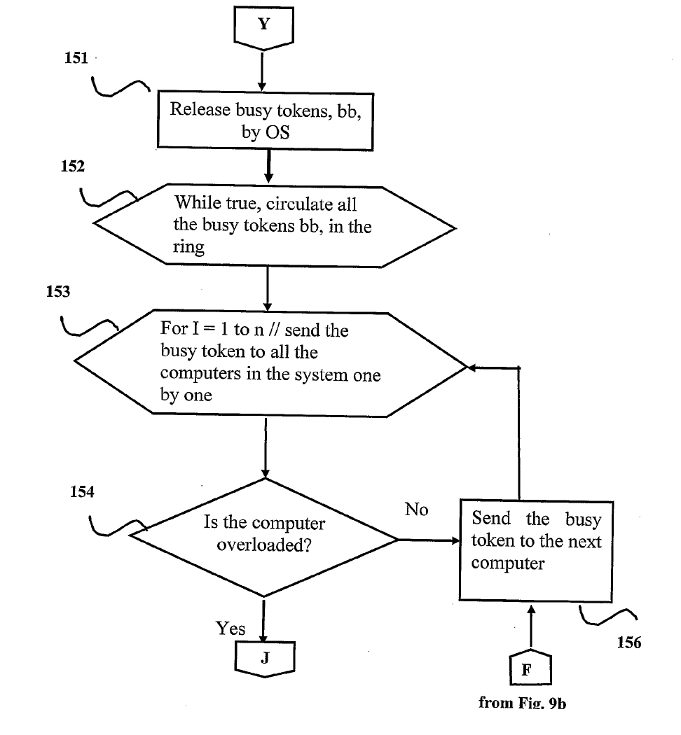

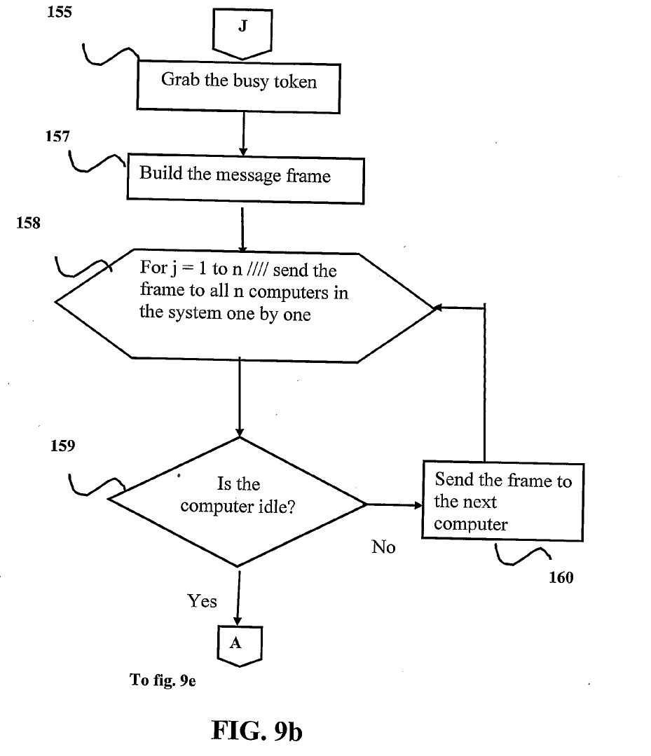

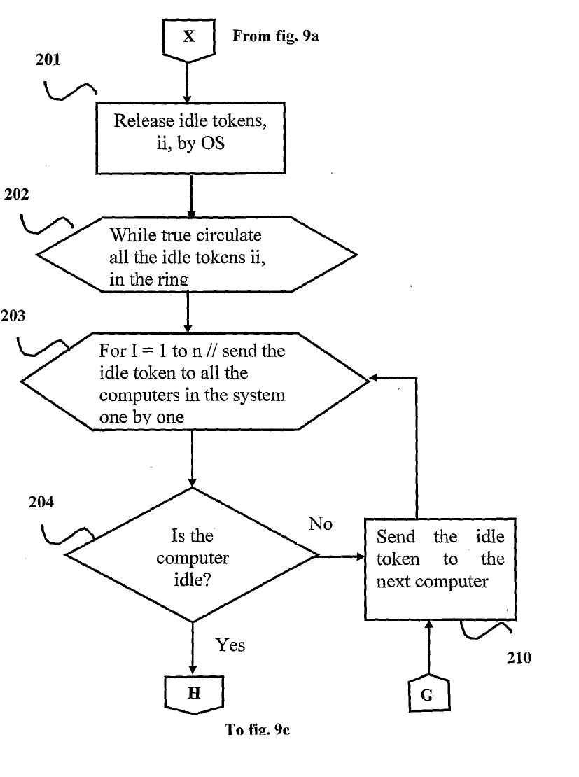

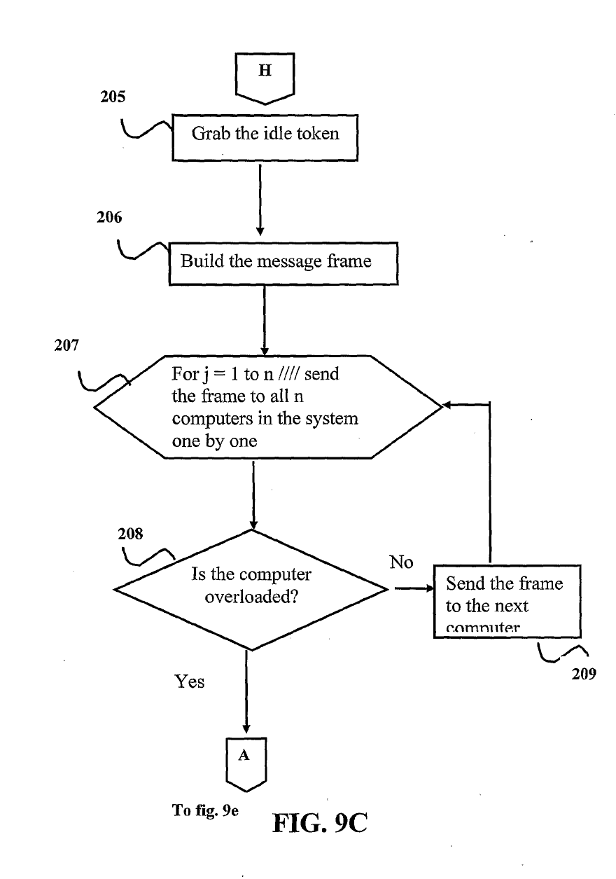

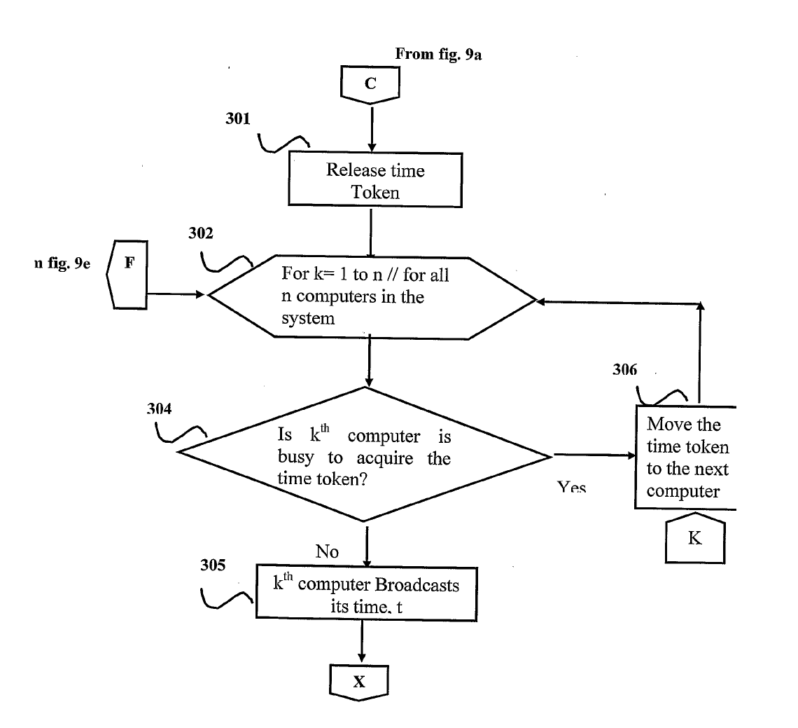

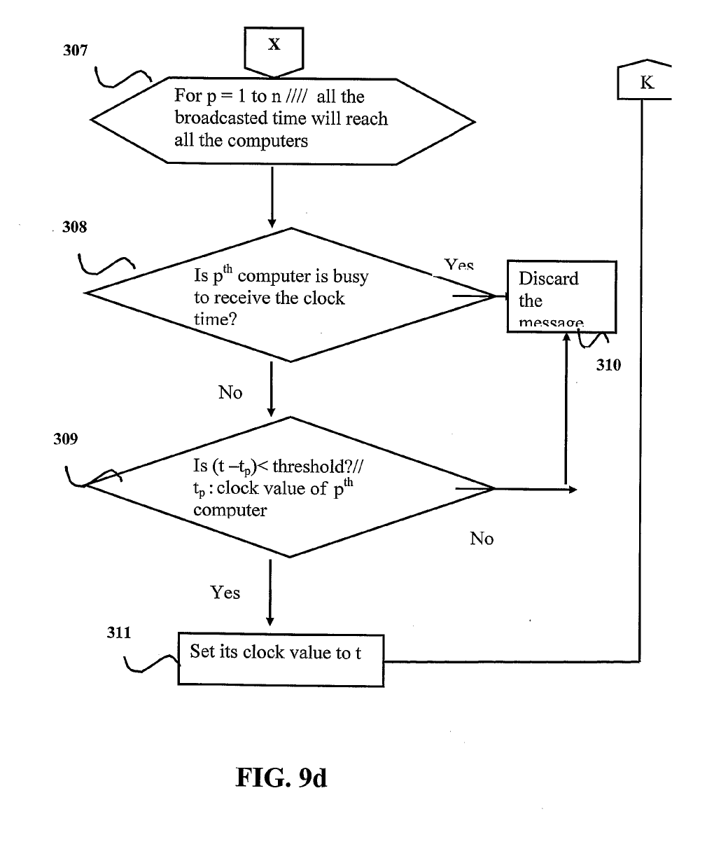

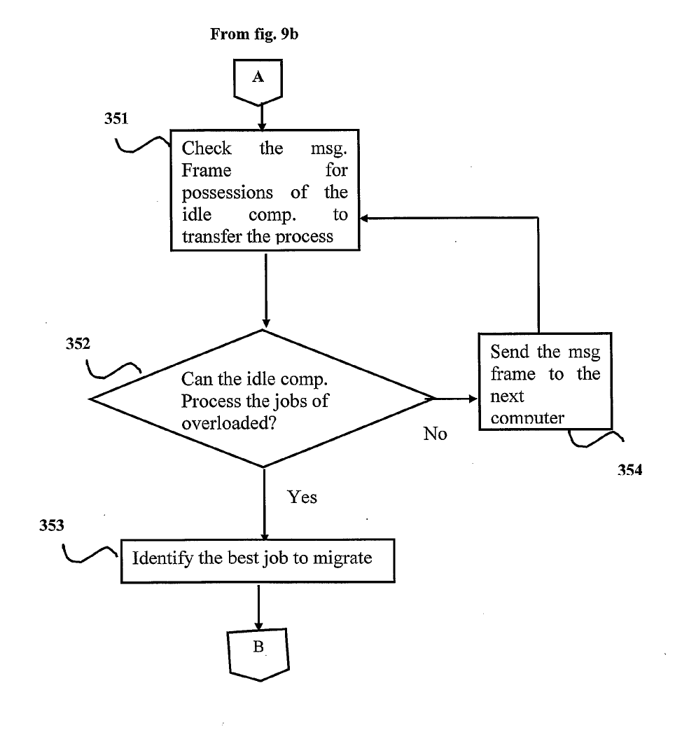

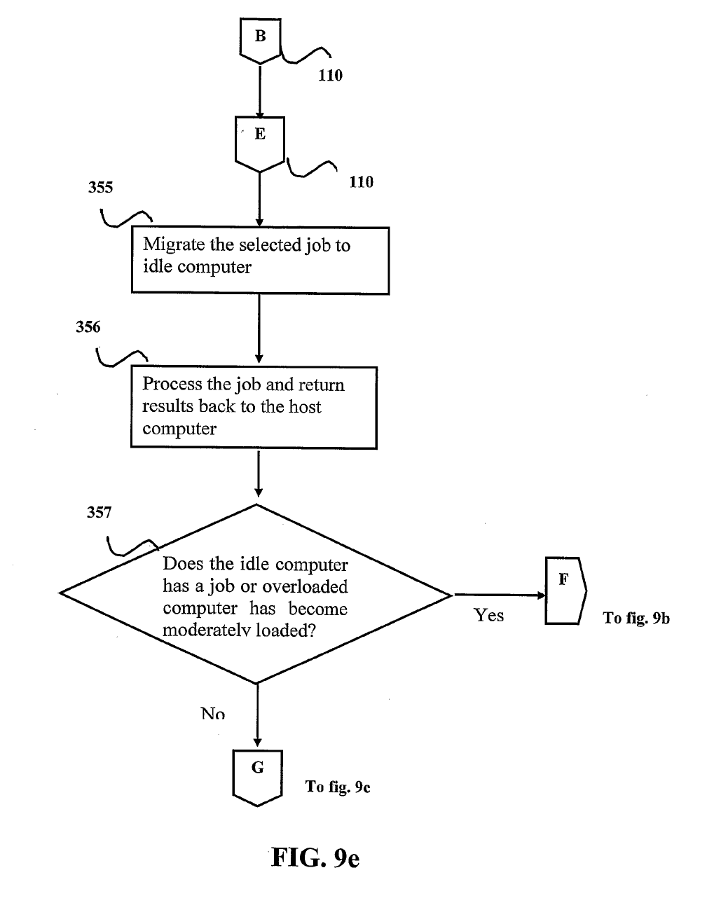

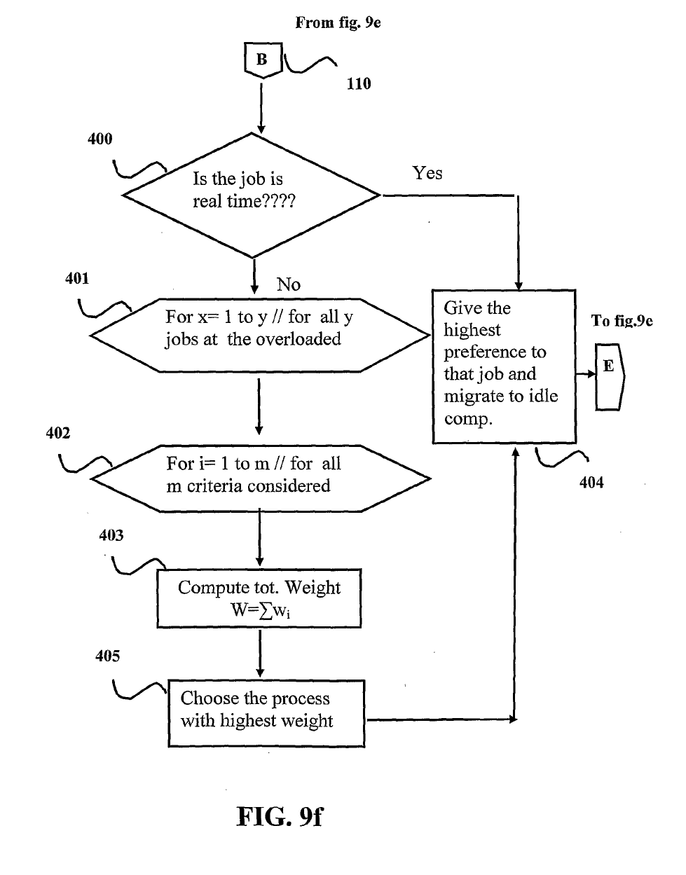

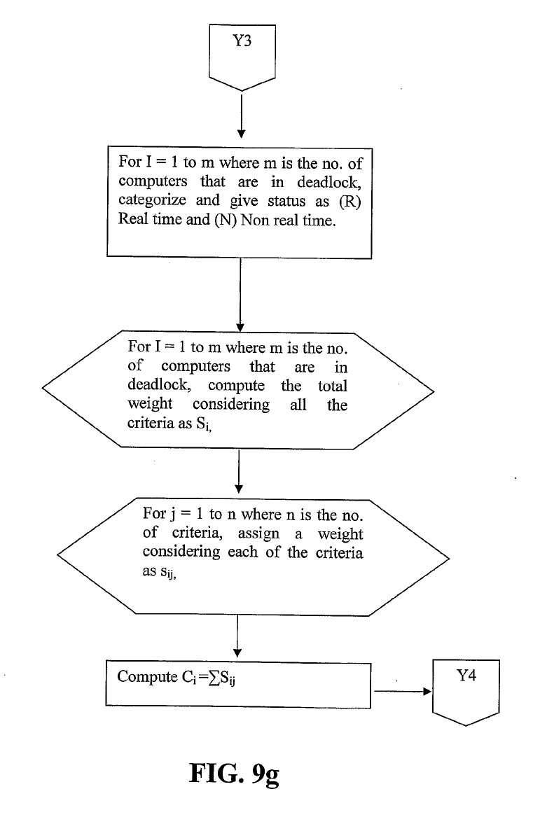

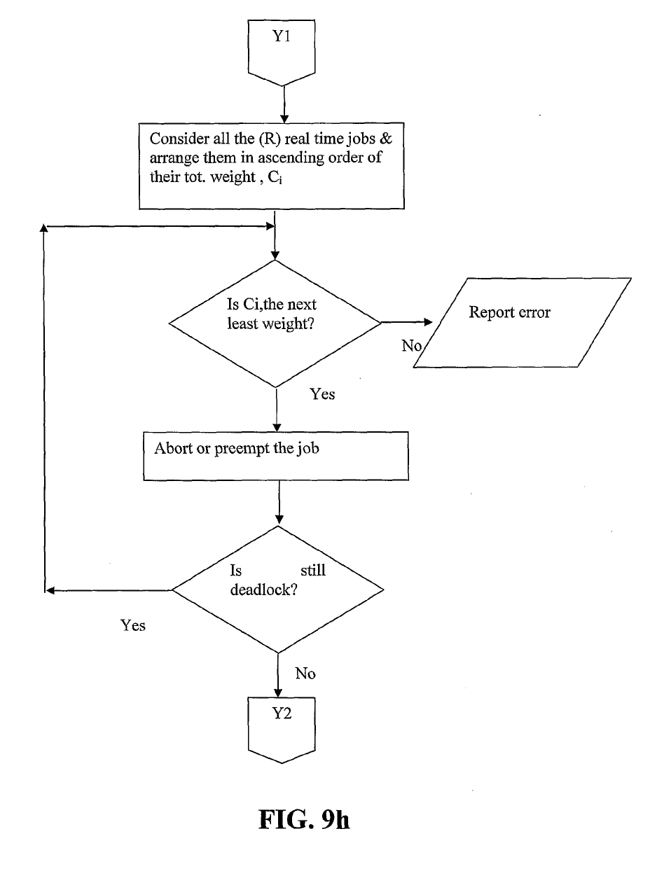

In an embodiment, (see FIGS. 9a-9c) the idle token method comprises designating a token as an idle token and circulating the idle token through the logical ring as shown in step 201. An idle computer that comes across this idle token first acquires the idle token as shown in step 205. The idle computer authenticates itself as idle for that instant and tends to convey a message indicative of idleness to all other computers in the ring. In an example, this is done by framing a message that comprises idleness information along with e.g. processor-id and the details of the idle computer such as, configuration, physical and logical resources. The message frame is sent to all computers in the logical ring as shown in step 206. On the way, whenever an overloaded computer receives the message frame, it checks the message frame to ascertain whether the particular idle computer can fulfill the requirements of any of the jobs that are ready in a queue.

In an embodiment, fulfilling requirement of an idle computer is checked by prioritizing the jobs based on a predetermined criteria and then scheduling the jobs. If none of the jobs at ready queue can be processed, then the overloaded computer lets the idle token to the neighboring computer. If any one or more jobs can be processed at that idle computer, then the overloaded computer transfers the best job along with processor-id and relevant data, to that idle computer as shown in step 355. The idle computer processes and sends the job results to the same overloaded computer as shown in step 356. Once the idle computer gets an acknowledgement from the overloaded computer about the receipt of the job results, the idle computer releases the idle token back into the ring. The process continues until the idle computer gets a job of its own and becomes busy or the overloaded computer becomes moderately loaded.

In an embodiment, the busy token method comprises designating a token as busy token indicative of an overload state of an overloaded computer and circulating the busy token through the logical ring. An overloaded computer that comes across the busy token acquires the busy token by authenticating itself to be overloaded for that instant as shown in steps 153 through 155. The overloaded computer frames a message with the details of the first prioritized job, e.g. with its logical and physical resources requirements, expected cpu time, etc. as shown in step 157. The message frame is made to circulate through the ring.

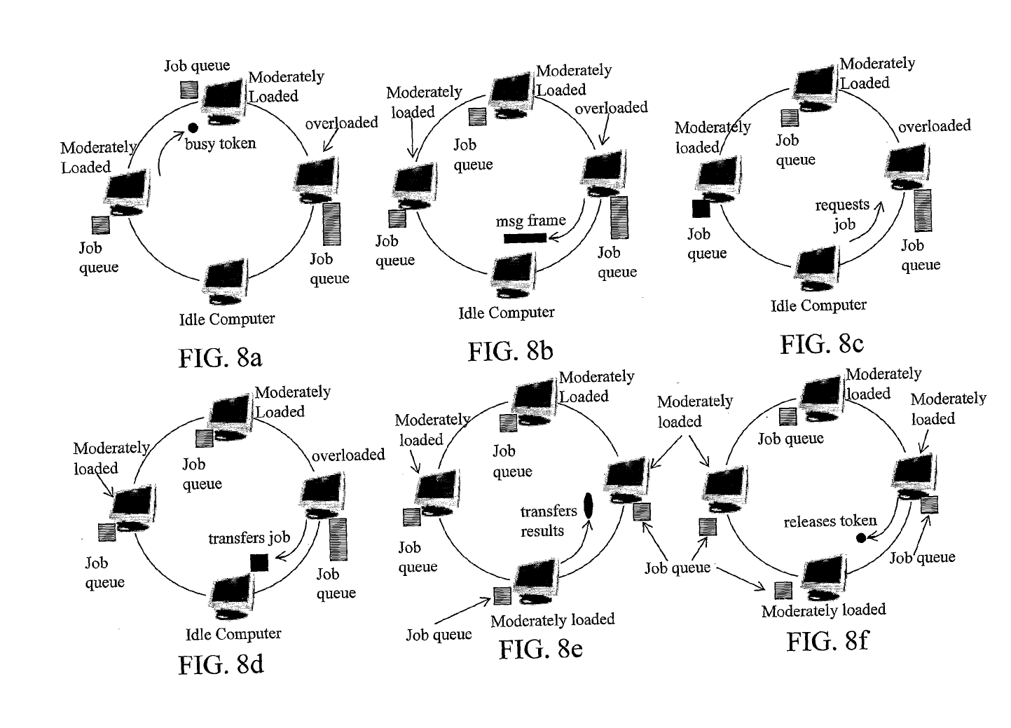

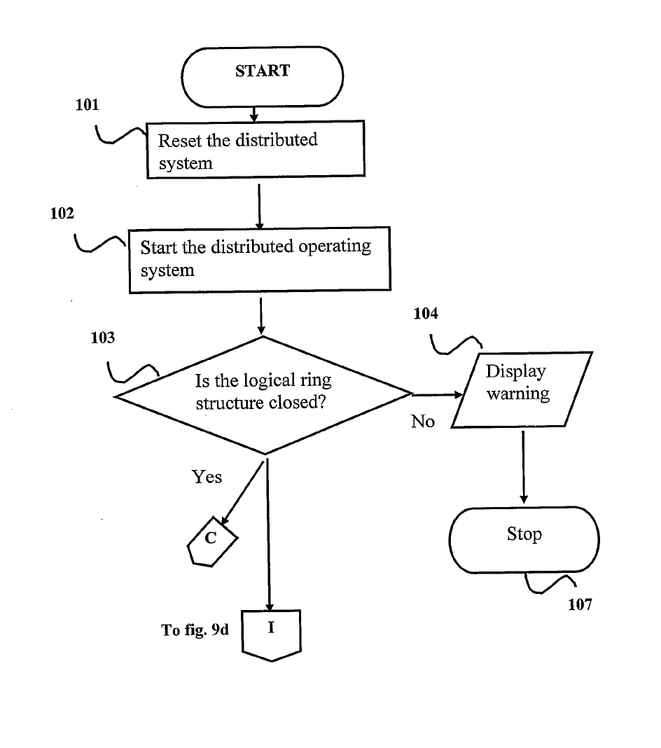

Whenever an idle computer receives the message frame, it checks the resource requirements and decides whether it can process this task. If yes, the idle computer requests the overloaded computer any suitable job to process on behalf of the overloaded computer. As a response the overloaded computer sends any one of the jobs at its ready queue as shown in FIG. 8d. The idle computer processes the job and sends back the results to the overloaded computer as shown in step 356 of FIG. 8e. Upon receiving this result, the idle computer releases the acquired busy token and is made to circulate through the logical ring again as seen in FIG. 8f. If the message frame is back to the sender for not finding any suitable or idle computer processes the job it should release the token to the ring and process the job itself. The process continues.

In an embodiment, in both the idle token method and the busy token method, the efficiency can be increased by having multiple tokens (not shown in fig.) so that maximum number of idle computers could be allotted with jobs from the overloaded computers and correspondingly the overloaded computers could be relieved off their overload. In the event of maximum overload, half the number of the computers are overloaded and rest are in idle state, wherein each idle computer is allocated a job of another overloaded computer. The optimum number of tokens can be n/2 for n number of computers in the distributed network.

However in both the idle token method and the busy token method, the choosing of the best job to submit to the idle computer out of many jobs at the overloaded computer becomes a crucial issue. In an embodiment, this is carried out by prioritizing the jobs by various criteria and selecting the best job, explained as follows:

Furthermore, the direction of movement of the idle token or the busy token is selected either anticlockwise or clockwise and is maintained consistent.

Referring to FIGS. 9g and 9h, for example, consider a queue with m jobs on an overloaded computer. Contextually, a computer is considered to be overloaded based on the number of jobs the computer has got in the queue. Now to select a job out of those m jobs available for the idle computer, weights are assigned to each of the job based on specific criteria. Examples of such criteria include:
(i) the expected time the idle computer is going to be free and available. This is a dynamic issue and statistically an estimate can be made based on the history of that computer. But this has an indirect impact on one of the job requirement factors, namely may be size of the job or the estimated processor time it is going to make use of. This scheme is described in detail in the later part of this description.
(ii) the resources the idle computer possesses. Examples of resources include memory, speed, physical resources etc.

Examples of the factors considered at the overloaded computer include:
(iii) the priority of the job
(iv) the size of the job
(v) the resources the job needs
(vi) arrival time of the job
(vii) the estimated processor time for completing the job, etc.,

The selection model based on the factors described above may be handled by either an overloaded computer or an idle computer. However in distributed computer systems, the overloaded computer has job on hand to process whereas the idle computer can afford to process. It should be noted that depending upon the simplicity of the method for selecting the job from the queue of the overloaded computer, the overhead required for this selection could be very nominal.

An example of a method for selecting a job for providing to the idle computer includes matching the idle computer's specifications with that of the overloaded computer's specifications with reference to different factors e.g. OS, speed, memory, coprocessor etc. If the specifications match, then the job is transferred to the idle computer. Else, the job scheduling needs consideration of other parameters of the distributed computer system. An example of a consideration includes that if the OS of both idle and busy computers are different, then another idle computer is searched in the distributed computer system.

Alternatively, the job requirements may be checked with the specification of the idle computer. There is a trade off between these two schemes of comparing specifications of idle computer and overloaded computer, and requirements of the job and specification of the idle computer. If it is desired to reduce the processing time for selection, then latter match becomes more demanding in terms of computations. All the jobs in the queue need to be checked. Such a check becomes a foolproof approach for determination of best-suited job to be selected.

In an embodiment, a method for prioritizing the jobs in the queue of the overloaded computer priorities includes considering the application and need of the resources for the application. Due to the dynamic nature of the parameters, priorities are set considering a multitasking and multi-user distributed computer systems. The selection of the scheme for scheduling is not unique and is application dependent.

For example, first and top preference is assigned to the real time job as shown in step 600, and the job is assigned a weight, say, W₁. In case there is more than one real time job, then another parameter is considered for selection. One of the measures is to consider time required for completion of the job. Depending upon the known time for which the idle computer is available, a suitable job can be selected as shown in step 601 through 604. A simple match can be done to select a particular job. This process may be continued until the overloaded computer becomes moderately loaded and the idle computer is free. However, to improve the efficiency, the longest job (in terms of computation time) may be selected provided the idle computer is free during that interval. Further job selection is made by selecting the next longer job if the idle computer is free.

In an example, when only non-realtime jobs are available, the estimated processor time each job requires and the expected duration the computer is going to be idle for are considered for prioritizing. The job, which fits best, is assigned a weight W₂ and is selected. This process continues till the overloaded computer becomes moderately loaded. When more than one job meets this requirement, preference will be given to the time of arrival of the job. The job that arrives first gets higher priority. The highest priority job selected is assigned a weight W₃.

Considering the scheduling operation for a few computers in the neighborhood, we can choose a job fitting a idle computer based on the assigned weights, given by:

w=Σwᵢ for i=1 to n

where “n” is the total number of criteria.

The above-mentioned procedure is repeated for all m jobs in the queue of the considered overloaded computer. Scheduling of the jobs is carried out by selecting a job with the highest weight. The job j is allotted before job i if and only if Wⱼ>Wᵢ for all i and j. If there are two or more jobs with the same weights then other parameters discussed earlier are considered.

In spite of all the care taken in allocating the jobs to different computers and resources to various jobs, there are several chances of the whole system or a part of the system suffers from “deadlock”. Dead lock is a condition where some or all the computers in the network are in an indefinite waiting state. The computers are waiting for some resources which are acquired by other computers of the network. As a measure of recovery from dead locks, the concept of preemption can be employed. In which case, the preempting of jobs continues till the dead lock is released. The identification of the job to be preempted is still a serious problem. A method where several criteria are considered and assigning the weightage to each job based on each of the criteria and a job with least weight will be preempted first and so on until the dead lock is released. The task is more serious as the case involves several jobs and plurality of computers.

When the jobs (waiting) of all the deadlocked computers are considered, the real time jobs are grouped as they require immediate processing. Hence, a flag is attached indicating that they are real time. They are given highest priority for execution and least priority for preemption. All the non real time tasks are given lesser priority for execution and higher priority for preemption. Several other criteria of all the jobs of all the computers suffering from the deadlock are considered as follows:
The jobs arrival time: the weight is assigned proportional to the arrival time. i.e., the job arrived first is assigned least weight and repeated accordingly to all the other jobs.
The number of resources the job has in hand: The weight assigned is proportionately based on the number of resources the job has acquired already.
The number of resources the job needs to proceed further: The weight assigned is inversely proportional to the number of resources the job needs to proceed further. More the number of resources it needs—assign lesser weight.
The number of child processes the job has: Assignment of the weight is proportional to the number of child processes it has.
The number of dependent jobs each job has: Assignment of the weight is proportional to the number of dependent processes it has.
The processor time each job has already made use of: Assign a weight that is proportional to the duration of processor time it has already made use of.
The processor time each job yet to make use of (estimate): Assign a weight inversely proportional to the processor time it further needs to complete.

For each of the weight Sᵢ for every criteria i and each computer j, Cⱼ=ΣSᵢ for i=1 to n, where n is the number of criteria considered; and j=1 to m where m is the number of computers in the deadlock state.

Since the method considers all the criteria, load balancing is carried out with improved efficiency and thereby chances of starvation is minimized.

After finding out the total weight of every job, consider all the jobs of non real time status first and preempt the job with the least weight and proceed accordingly till there is no deadlock. Once all the non real time jobs are preempted and still there is deadlock, then start preempting real time jobs on the same criteria as said above till there is no dead lock.

However all the events of sending the message, tokens, acknowledging and acquiring the tokens, migrating the jobs, getting the results back etc. need to be synchronized so that there exists no conflict between the computers. The events are synchronized, by synchronizing the clocks of all the participating and preferably all the computers in the distributed computer system.

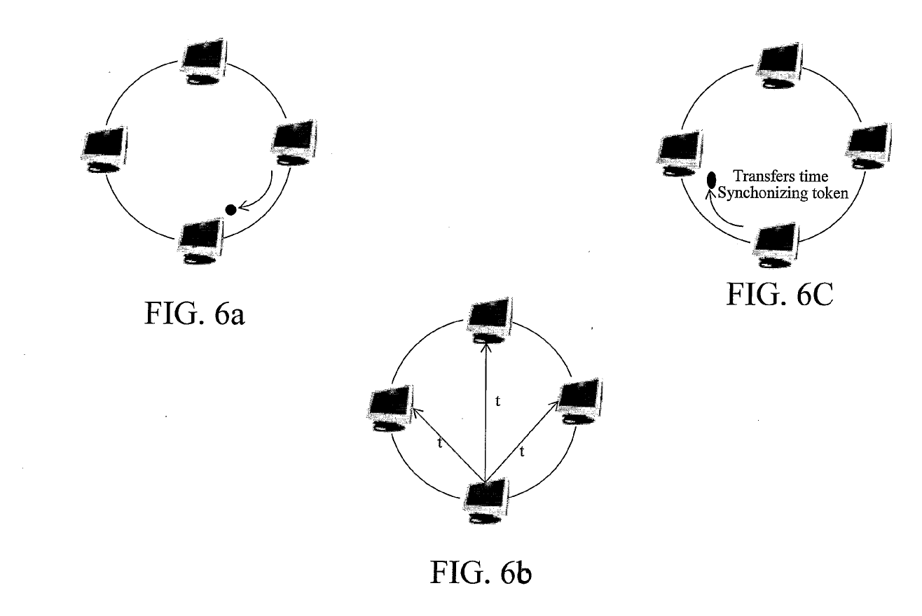

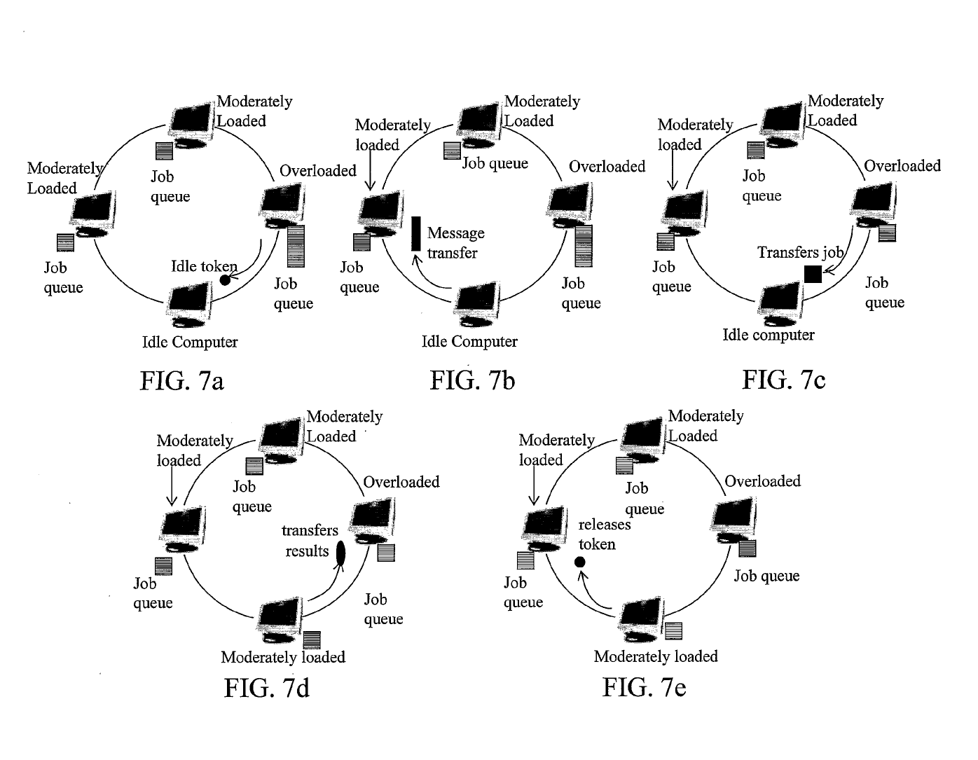

In an embodiment, time synchronization is accomplished by connecting the computers in a logical ring architecture, based on predetermined criteria. A bit pattern, referred to as token carrying a time message is circulated in the ring, as shown in FIG. 6a and step 301. Whenever a computer comes across the token, it becomes the authorized timeserver as in FIG. 6b, for that instant. The authorized computer grabs the token as shown in step 305 and broadcasts its time to all other computers in the distributed computer system as shown in FIG. 6b. When each computer receives the broadcast time as in step 307, it set its clock value to the said time in the message (not shown in the fig.). Then, the beholder lets the token to its neighboring computer, as in FIG. 6c. In case of any computer failure, the token moves on to the next computer, leaving the failed computer in-between (not shown) and the process continues.

For example, due to some reason, say, media problem or sender's clock problem, if the time broadcasted is too vague, then an error factor, [symbol] , is set i.e., when a computer receives a time which is beyond the threshold value, its clock value+ [symbol] , then the computer neglects that message as shown in steps 309 and 310.

For example, if the receiver computer is too busy to receive the time packet, processing a non-maskable interrupt or an atomic transaction, it may neglect that message as shown in steps 304 and 306.

However initial setting of a computer clock when it gets introduced at the start up time is set in coordination with the received propagated time, as it might ignore the received correct clock value because of its own wrong timing, in turn [symbol] be too large and hence gets neglected.

It should be noted that the above-mentioned methods according to this invention provides the following advantages: (i) As in any known centralize method like, Berkeley and Cristian, there is no centralized dependency for synchronization purpose; (ii) unlike the known method such as, distributed averaging methods, in the methods according to this invention, each computer does not have considerable load for synchronization; (iii) all the computers in the network are physically synchronized, enabling communication between any two or more computers in the network; (iv) scalability is easily achieved; (v) as the time setting is done periodically, the difference in the time values of any two clocks, clock skew, is also taken care; and hence achieves logical synchronization.

Further advantages of the methods according to the embodiments disclosed in this invention, include: (i) saves a dedicated computer designated as coordinator; (ii) saves from the worst consequence of a centralized coordinator failure; (ii) saves too many messages of broad casting being transmitted over the network for each allotment, which in turn increases network traffic; (iv) saves each computer from maintaining the details of all other computers; (iv) a computer, which is always kept busy, for e.g., the computer of the CAO of a Military Army Regime seldom gets chance to process other over loaded computers' job, but still maintains a huge directory of information about all other systems in the network.

Thus, various specific embodiments describe a method and system for load balancing in a distributed computer system. Further embodiments describe a distributed computer system.

Various modifications of this invention are possible. However, it will be recognized by those skilled in the art that all such modifications have been deemed to be covered by this invention and are within the spirit and scope of the claims appended hereto.

1. A load balancing method using an idle token, in a distributed computer system, comprising:
(i) connecting a plurality of computers in a substantial logical ring architecture based on one or more predetermined criteria;
(ii) counting the number of idle and overloaded computers, periodically;
(iii) circulating at least one predetermined idle token through the logical ring if the number of idle computers exceeds the number of overloaded computers;
(iv) configuring at least one idle computer to acquire the idle token for framing and thereby circulating a message indicative of an idle state and the configuration data of the idle computer to other computers in the logical ring; and
(v) configuring at least one overloaded computer to transfer a predetermined job to the idle computer for completion, based on the idle state and the suitability of the configuration to complete the job.

2. A load balancing method according to claim 1 wherein the criteria for connecting the computers in the logical ring architecture includes one or more among physical distance, processor ID and processor priority.

3. A load balancing method according to claim 1 further comprising checking the closed state of the logical ring architecture prior to step (ii).

4. A load balancing method according to claim 1 further comprising transferring the job to the idle computer based on one or more among job priority, job size, available resources, job arrival time and job processing time.

5. A load balancing method according to claim 4 wherein job priority is set by assigning a weight to the job based on at least one of a free time availability of the idle computer and the resources available with the idle computer.

6. A load balancing method according to claim 1 wherein a plurality of idle tokens are circulated, wherein the optimum number of idle tokens is equal to half of the total number of computers in the logical ring.

7. A load balancing method according to claim 1 further comprising configuring the idle computer to return the result of the completed job to the overloaded computer, receive acknowledgement from the overloaded computer, and release the idle token for circulation in the logical ring.

8. A load balancing method according to claim 1 further comprising circulating a time synchronizing token to synchronize the clocks of all the computers in the logical ring.

9. A load balancing method according to claim 1 further comprising considering a computer to be overloaded if the number of jobs in the processing queue reaches a predetermined threshold value.

10. A load balancing method according to claim 1 further comprising preempting the jobs wherein such preempting releases the deadlock in the distributed computer system.

11. A load balancing method according to claim 10 further comprising assigning weights to each one of the jobs based on predetermined criteria and preempting the jobs based on the assigned weights.

12. A load balancing method according to claim 11 wherein the criteria for assigning weights comprises at least one of job arrival time, number of resources acquired and pending for a job, number of child processes for the job, number of dependent jobs, and processing time.

13. A load balancing method according to claim 11 further comprising selecting the non-real time jobs and preempting the non-real time jobs in order of their assigned weights.

14. A load balancing method using a busy token, in a distributed computer system, comprising:
(i) connecting a plurality of computers in a substantial logical ring architecture based on one or more predetermined criteria;
(ii) counting the number of idle and overloaded computers periodically;
(iii) circulating at least one predetermined busy token through the logical ring if the number of overloaded computers exceeds the number of idle computers;
(iv) configuring at least one overloaded computer to acquire the busy token, frame and thereby circulate a message indicative of an overload status and the required resources for completing a predetermined job to other computers in the logical ring; and
(v) configuring at least one idle computer to check the message and provide a job request to the overloaded computer depending upon the overload status and availability of required resources for completing the job, wherein the overloaded computer transfers the job to the idle computer subsequent to the request.

15. A load balancing method according to claim 14 wherein the criteria for connecting the computers in the ring architecture includes one or more among physical distance, processor ID and processor priority.

16. A load balancing method according to claim 14 further comprising checking the closed state of the logical ring architecture prior to step (ii).

17. A load balancing method according to claim 14 comprising transferring the job to the idle token based on one or more among job priority, job size, job resource, job arrival time and job processing time.

18. A load balancing method according to claim 17 wherein the job priority is set by assigning a weight to the job based on the resources available with the idle computer.

19. A load balancing method according to claim 14 comprising a plurality of busy tokens wherein the optimum number of tokens is equal to an half of the total number of computers in the logical ring.

20. A load balancing method according to claim 14 further comprising configuring the idle computer to return the job result to the overloaded computer, and again circulating the busy token in the logical ring.

21. A load balancing method according to claim 14 further comprising circulating a time synchronizing token to synchronize the clocks of all the computers in the logical ring.

22. A load balancing method according to claim 14 further comprising considering a computer to be overloaded if the number of jobs in processing queue reaches a predetermined threshold.

23. A load balancing method according to claim 14 further comprising preempting the jobs wherein such preempting releases the deadlock in the distributed computer system.

24. A load balancing method according to claim 23 further comprising assigning weights to each one of the jobs based on predetermined criteria and preempting the jobs based on the assigned weights.

25. A load balancing method according to claim 24 wherein the criteria for assigning weights comprises at least one of job arrival time, number of resources acquired and pending for a job, number of child processes for the job, number of dependent jobs, and processing time.

26. A load balancing method according to claim 23 further comprising selecting the non-real time jobs and preempting the non-real time jobs in order of their assigned weights.

27. A distributed computer system, comprising:
(i) a plurality of computers connected in a substantial logical ring architecture;
(ii) said computers configured having a synchronized clock operation; and
(iii) at least one predetermined token designated with any one of a busy or an idle status circulating through the logical ring, wherein the computers are configured to check the status and give away or receive a predetermined job for completion, based on one or more predetermined conditions.

28. A distributed computer system according to claim 27 wherein the token comprises a predetermined bit pattern configured to circulate through the logical ring.

29. A distributed computer system according to claim 27 wherein the job is given away or received by the computers based on one or more among job priority, job size, job resource, job arrival time and job processing time.

30. A distributed computer system according to claim 27 wherein the computer is configured having reached a busy status if the number of jobs in the processing queue reaches a predetermined threshold.

31. A distributed computer system according to claim 27 wherein job priority is set by assigning a weight to the job based on at least one of a free time availability and the resources available with the idle computer.

32. A distributed computer system according to claim 27 further comprising preempting the jobs wherein such preempting releases the deadlock in the distributed computer system.

33. A load balancing method according to claim 23 further comprising assigning weights to each one of the jobs based on predetermined criteria and preempting the jobs based on the assigned weights.

34. A load balancing method according to claim 24 wherein the criteria for assigning weights comprises at least one of job arrival time, number of resources acquired and pending for a job, number of child processes for the job, number of dependent jobs, and processing time.

35. A load balancing method according to claim 23 further comprising selecting the non-real time jobs and preempting the non-real time jobs in order of their assigned weights.
